(19) United States
(12) Patent Application Publication
(10) Pub. No.: US 2016/0054120 A1
(43) Pub. Date: Feb. 25, 2016

(54) AUTOMATED UPPER/LOWER HEAD CROSS DIRECTION ALIGNMENT BASED ON MEASUREMENT OF SENSOR SENSITIVITY

(71) Applicant: Honeywell ASCa Inc., Mississauga (CA)

(72) Inventor: Ronald E. Beselt, Burnaby (CA)

(21) Appl. No.: 14/466,491

(22) Filed: Aug. 22, 2014

(51) Int. Cl. G01B 11/27

(52) U.S. Cl. CPC G01B 11/272

(57) ABSTRACT

A method includes moving a first sensor assembly to a plurality of cross direction positions relative to a second sensor assembly, where the first and second sensor assemblies are configured to move in the cross direction relative to a web of material. The method also includes, for each of the plurality of cross direction positions, determining a sensor value associated with a sensor source disposed at the second sensor assembly as measured by a sensor receiver disposed at the first sensor assembly. The method further includes determining a starting alignment position of the first sensor assembly to be a first cross direction position where a difference between the sensor value at the first cross direction position and a corresponding sensor value at one or more adjacent cross direction positions is a minimum.

### TECHNICAL FIELD

This disclosure relates generally to scanning measurement systems. More specifically, this disclosure relates to automated cross direction alignment of upper and lower scanning heads based on measurement of sensor sensitivity.

### BACKGROUND

Sheets or other webs of material are used in a variety of industries and in a variety of ways. These materials can include paper, multi-layer paperboard, and other products manufactured or processed in long webs. As a particular example, long sheets of paper can be manufactured and collected in reels.

It is often necessary or desirable to measure one or more properties of a web of material as the web is being manufactured or processed. Adjustments can then be made to the manufacturing or processing system to ensure that the properties stay within desired ranges. Measurements are often taken using one or more scanning heads that move back and forth across the width of the web.

### SUMMARY

This disclosure provides automated cross direction alignment of upper and lower scanning heads based on measurement of sensor sensitivity.

In a first embodiment, a method includes moving a first sensor assembly to a plurality of cross direction positions relative to a second sensor assembly, where the first and second sensor assemblies are configured to move in the cross direction relative to a web of material. The method also includes, for each of the plurality of cross direction positions, determining a sensor value associated with a sensor source disposed at the second sensor assembly as measured by a sensor receiver disposed at the first sensor assembly. The method further includes determining a starting alignment position of the first sensor assembly to be a first cross direction position where a difference between the sensor value at the first cross direction position and a corresponding sensor value at one or more adjacent cross direction positions is a minimum.

In a second embodiment, an apparatus includes a first sensor assembly configured to move in a cross direction relative to a web of material. The first sensor assembly includes at least one controller and a sensor receiver configured to receive and measure emissions from a sensor source disposed at a second sensor assembly. The at least one controller is configured to control a motor that is configured to move the first sensor assembly to a plurality of cross direction positions relative to the second sensor assembly. The at least one controller is also configured to determine, for each of the plurality of cross direction positions, a sensor value associated with the sensor source as measured by the sensor receiver. The at least one controller is further configured to determine a starting alignment position of the first sensor assembly to be a first cross direction position where a difference between the sensor value at the first cross direction position and a corresponding sensor value at one or more adjacent cross direction positions is a minimum.

In a third embodiment, a system includes a first sensor assembly and a second sensor assembly. The first sensor assembly is configured to be disposed on a first side of a web of material and to move in a cross direction relative to the web. The second sensor assembly is configured to be disposed on a second side of the web opposite the first side and to move in the cross direction. The first sensor assembly is configured to move to a plurality of cross direction positions relative to the second sensor assembly. The first sensor assembly is also configured, for each of the plurality of cross direction positions, to determine a sensor value associated with a sensor source disposed at the second sensor assembly as measured by a sensor receiver disposed at the first sensor assembly. The first sensor assembly is further configured to determine a starting alignment position of the first sensor assembly to be a first cross direction position where a difference between the sensor value at the first cross direction position and a corresponding sensor value at one or more adjacent cross direction positions is a minimum.

In a fourth embodiment, a non-transitory computer readable medium embodies a computer program. The computer program includes computer readable program code for moving a first sensor assembly to a plurality of cross direction positions relative to a second sensor assembly, where the first and second sensor assemblies are configured to move in the cross direction relative to a web of material. The computer program also includes computer readable program code for determining, for each of the plurality of cross direction positions, a sensor value associated with a sensor source disposed at the second sensor assembly as measured by a sensor receiver disposed at the first sensor assembly. The computer program further includes computer readable program code for determining a starting alignment position of the first sensor assembly to be a first cross direction position where a difference between the sensor value at the first cross direction position and a corresponding sensor value at one or more adjacent cross direction positions is a minimum.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a portion of an example web-making or web-processing system in accordance with this disclosure;

FIGS. 2A through 2C illustrate example scanning sensor assemblies in the system of FIG. 1 and potential alignment errors that may occur between sensor assemblies during scanning operations in the system of FIG. 1 in accordance with this disclosure;

FIG. 3 illustrates an example scanning sensor head in the scanning sensor assembly of FIG. 1 in accordance with this disclosure;

FIG. 4 illustrates an example method for calibrating an alignment of sensors installed on independently-driven scanning sensor heads in accordance with this disclosure;

FIG. 5 illustrates an example chart showing sensor signal outputs versus cross direction position profiles in accordance with this disclosure; and

FIG. 6 illustrates an example chart showing sensor measurement readings versus cross direction positions for multiple types of sensors in accordance with this disclosure.

### DETAILED DESCRIPTION

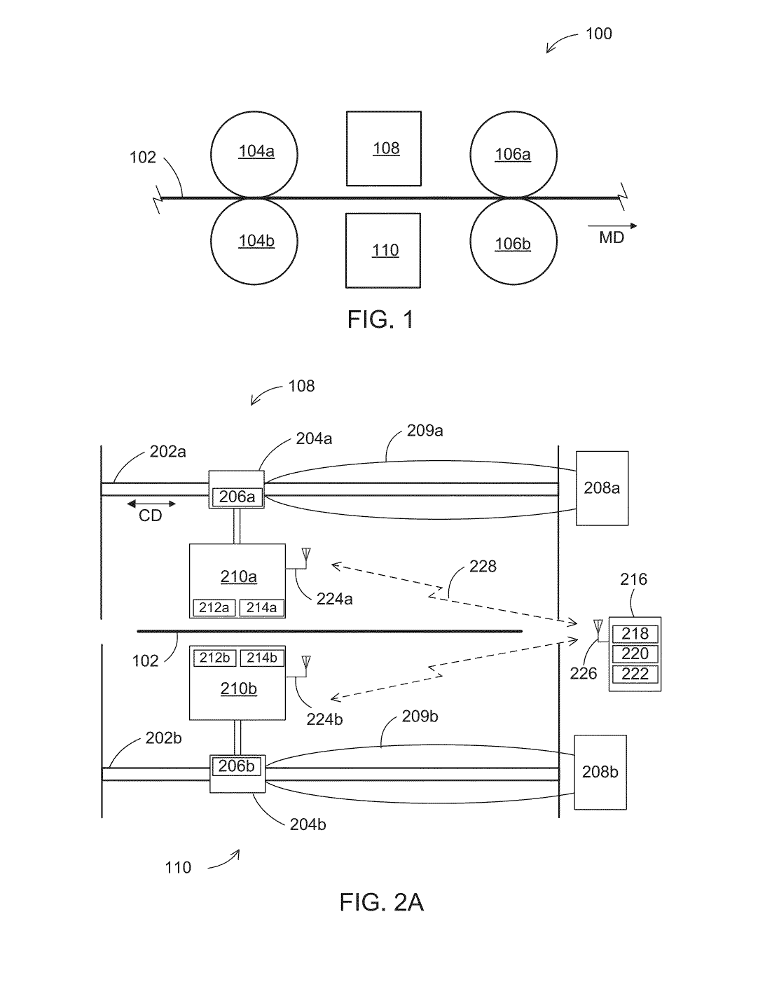

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Scanning systems for sheet- or other web-related processes often use translating scanning heads that house sensors and move back and forth across each side of the web. In some systems, the sensors can be arranged such that a source device and a receiver device are located on opposite sides of the web. The location of the receiver device relative to the source device can have an impact on measured signals, which can cause errors in sensor measurements. In many cases, alignment features on the scanning heads are used to center the sensors relative to each other.

In many systems, upper and lower sensor heads are mechanically coupled to a belt system mounted to a frame and end supports and are driven by a single motor. In these systems, alignment of the sensors in the scanning direction is determined by the accuracy of the belt tooth structure in the drive system. In other systems, upper and lower sensor heads are mechanically uncoupled and are driven independently with separate motors. In those systems, alignment of the sensors may be achieved electronically, such as via one or more position sensors and positional control algorithms.

Sensors are often designed to have a low sensitivity to displacement when they are centered directly opposite from each other. Manufacturing variations in the sensors and variations in mounting the sensors may result in the location of lowest displacement sensitivity being off-center. Stated another way, even though sensor heads may be in perfect or near-perfect alignment, the sensors themselves may still be out of alignment due to manufacturing and installation differences. Confirming and measuring source-to-receiver alignment by manually moving sensor heads relative to each other is a time consuming and error prone process.

Embodiments of this disclosure solve the problem of sensor alignment by measuring sensor sensitivity in an off-sheet alignment calibration process. This alignment calibration process can be performed automatically prior to scanning, such as on a periodic basis, or as part of a diagnostic or maintenance routine to measure sensitivities.

FIG. 1 illustrates a portion of an example web-making or web-processing system 100 in accordance with this disclosure. As shown in FIG. 1, the system 100 manufactures or processes a continuous web 102. The web 102 can represent any suitable material or materials manufactured or processed as moving sheets or other webs. Example webs 102 can include paper, multi-layer paperboard, cardboard, plastic, textiles, or metal webs.

In this example, the web 102 is transported through this portion of the system 100 using two pairs of rollers 104a-104b and 106a-106b. For example, the roller pair 104a-104b can pull the web 102 from a previous stage of a web-manufacturing or web-processing system. Also, the roller pair 106a-106b can feed the web 102 into a subsequent stage of the web-manufacturing or web-processing system. The roller pairs 104a-104b and 106a-106b move the web 102 in a direction referred to as the “machine direction” (MD).

Two or more scanning sensor assemblies 108-110 are positioned between the roller pairs 104a-104b and 106a-106b. Each scanning sensor assembly 108-110 includes one or more sensors capable of measuring at least one characteristic of the web 102. For example, the scanning sensor assemblies 108-110 could include sensors for measuring the moisture, caliper, anisotropy, basis weight, color, gloss, sheen, haze, surface features (such as roughness, topography, or orientation distributions of surface features), or any other or additional characteristic(s) of the web 102. In general, a characteristic of the web 102 can vary along the length of the web 102 (in the “machine direction”) and/or across the width of the web 102 (in a “cross direction” or “CD”). Each scanning sensor assembly 108-110 includes any suitable structure or structures for measuring or detecting one or more characteristics of a web. Each sensor assembly 108-110 is configured to move back and forth (in the cross direction) across the web 102 in order to measure one or more characteristics across the width of the web 102.

Each scanning sensor assembly 108-110 can communicate wirelessly or over a wired connection with an external device or system, such as a computing device that collects measurement data from the scanning sensor assemblies 108-110. For example, each scanning sensor assembly 108-110 could communicate with an external device or system to synchronize a clock of that sensor assembly 108-110 with the clock of the external device or system.

Unlike scanner systems in which different assemblies are mechanically coupled to maintain alignment, the scanning sensor assemblies 108-110 are not mechanically coupled and are independently moveable. However, there are many instances in which it is desirable for the scanning sensor assemblies 108-110 to maintain alignment with each other as the sensor assemblies 108-110 move. In some embodiments, the sensor assembly 108 can be a master sensor assembly, and the sensor assembly 110 can be a follower sensor assembly (or vice versa). The master sensor assembly moves back and forth across all or a portion of the width of the web 102 according to a sensor assembly motion profile. The follower sensor assembly follows the movement of the master sensor assembly in order to maintain alignment with the master sensor assembly. In accordance with this disclosure, an off-sheet alignment calibration process can be performed using the sensor assemblies 108-110 to fine tune the alignment of the sensors as described in greater detail below.

Although FIG. 1 illustrates a portion of one example web-making or web-processing system 100, various changes may be made to FIG. 1. For example, while the scanning sensor assemblies 108-110 are shown here as being used between two pairs of rollers, the scanning sensor assemblies 108-110 could be used in any other or additional location(s) of a web-making or web-processing system. Moreover, FIG. 1 illustrates one operational environment in which alignment techniques for independently driven, dual sided scanner heads can be used. This functionality could be used in any other type of system.

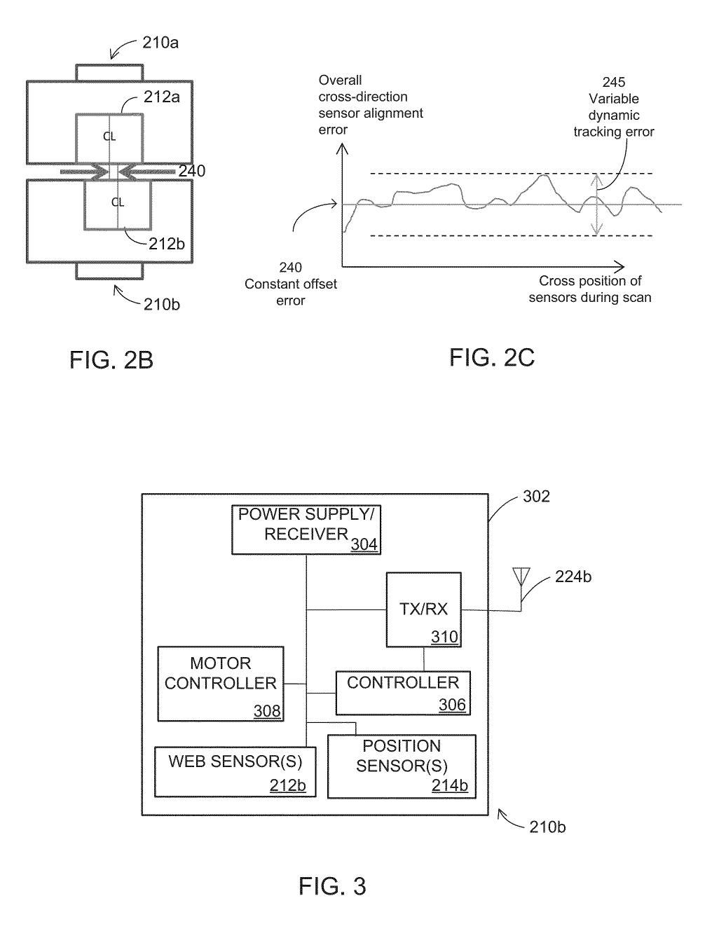

FIGS. 2A through 2C illustrate example scanning sensor assemblies 108-110 in the system 100 of FIG. 1 and potential alignment errors that may occur between sensor assemblies 108-110 during scanning operations in the system 100 of FIG. 1 in accordance with this disclosure. In the following discussion, it is assumed that the sensory assembly 108 is the master assembly and the sensory assembly 110 is the follower assembly. Much of the structure of the sensor assembly 108 is the same as or similar to the structure of the sensor assembly 110. Where the structure of the sensor assembly 110 differs from the structure of the sensor assembly 108, those differences are highlighted below.

As shown in FIG. 2A, each scanning sensor assembly 108-110 includes a respective track 202a-202b on which a respective carriage 204a-204b travels. In the system 100, each track 202a-202b could generally extend in the cross direction across the width of the web 102. Each carriage 204a-204b can traverse back and forth along its track 202a-202b to move one or more sensors back and forth across the web 102. Each track 202a-202b generally includes any suitable structure on which other components of a sensor assembly can move, such as a belt, shaft, or beam formed of metal or another suitable material. Each carriage 204a-204b includes any suitable structure for moving along a track.

Various mechanisms can be used to move the carriages 204a-204b along the tracks 202a-202b or to position the sensor assemblies 108-110 at particular locations along the tracks 202a-202b. For example, each carriage 204a-204b could include a respective motor 206a-206b that moves the carriage 204a-204b along its track 202a-202b. As another example, external motors 208a-208b could move belts 209a-209b that are physically connected to the carriages 204a-204b, where the belts 209a-209b move the carriages 204a-204b along the tracks 202a-202b. Any other suitable mechanism for moving each carriage 204a-204b along its track 202a-202b could be used.

Scanning sensor heads 210a-210b are connected to the carriages 204a-204b. Each sensor head 210a-210b respectively includes at least one web sensor 212a-212b that captures measurements associated with the web 102. Each sensor head 210a-210b includes any suitable structure for carrying one or more sensors. Each web sensor 212a-212b includes any suitable structure for capturing measurements associated with one or more characteristics of a web. The web sensors 212a-212b may represent a contact sensor that takes measurements of a web via contact with the web or a non-contact sensor that takes measurements of a web without contacting the web.

In many systems, a web sensor 212a-212b could include a source element mounted on one of the sensor heads 210a-210b and a receiver element mounted on the other of the sensor heads 210a-210b. The web sensor 212a could represent the source element, and the web sensor 212b could represent the receiver element (or vice versa). In some embodiments, the source element may be an emitter of nuclear radiation, infrared light, visible light, a magnetic field, or any other suitable type of emission. Similarly, the receiver element may be a receiver or detector configured to receive and measure nuclear radiation, infrared light, visible light, a magnetic field, or any other suitable type of emission. As particular examples, the receiver may be an ion chamber, a light detector, or a camera.

Each sensor head 210a-210b also respectively includes at least one position sensor element 214a-214b for capturing relative or absolute “cross direction” positional information of that sensor head 210a-210b for use in aligning the sensor assemblies 108-110. Each position sensor element 214a-214b includes any suitable structure for capturing positional information of a corresponding sensor head relative to the web 102 or another calibrated reference point (such as a linear scale) or for determining a difference in cross direction position of the follower sensor assembly 110 relative to the master sensor assembly 108.

Power can be provided to each sensor head 210a-210b in any suitable manner. For example, each sensor head 210a-210b could be coupled to one or more cables that provide power to that sensor head. As another example, each carriage 204a-204b could ride on one or more cables or rails used to supply power to the associated sensor head 210a-210b. Each sensor head 210a-210b could further include an internal power supply, such as a battery or an inductive coil used to receive power wirelessly. Each sensor head 210a-210b could be powered in any other or additional manner.

In this example, each sensor head 210a-210b can send sensor measurement data to an external controller 216. The controller 216 could use the measurement data in any suitable manner. For example, the controller 216 could use the measurement data to generate CD profiles of the web 102. The controller 216 could then use the CD profiles to determine how to adjust operation of the system 100. The controller 216 could also use the CD profiles or the measurement data to support monitoring applications, process historian applications, or other process control-related applications.

The controller 216 includes any suitable structure(s) for receiving sensor measurement data, such as one or more computing devices. In particular embodiments, the controller 216 includes one or more processing devices 218, such as one or more microprocessors, microcontrollers, digital signal processors, field programmable gate arrays, or application specific integrated circuits. The controller 216 also includes one or more memories 220, such as one or more volatile and/or non-volatile storage devices, configured to store instructions and data used, generated, or collected by the processing device(s) 218. In addition, the controller 216 includes one or more interfaces 222 for communicating with external devices or systems, such as one or more wired interfaces (like an Ethernet interface) or one or more wireless interfaces (like a radio frequency transceiver). The controller 216 could represent all or part of a centralized control system or part of a distributed control system. In particular embodiments, the controller 216 includes a measurement subsystem (MSS), which interacts with the sensor assemblies 108-110 to obtain and process measurements of the web 102. The processed measurements can then be provided to other components of the controller 216.

Each sensor head 210a-210b and the controller 216 can communicate wirelessly or via a wired connection. In the embodiment shown in FIG. 2A, each sensor head 210a-210b is configured for wireless communication and respectively includes at least one antenna 224a-224b, and the controller 216 includes at least one antenna 226. The antennas 224-226 support the exchange of wireless signals 228 between the sensor heads 210a-210b and the controller 216. For example, the controller 216 could transmit commands instructing the sensor heads 210a-210b to capture measurements of the web 102, and the sensor heads 210a-210b can transmit web measurements, positional information, and associated alignment data to the controller 216. The sensor heads 210a-210b could also transmit other data to the controller 216, such as diagnostic data. Each antenna 224a, 224b, 226 includes any suitable structure for transmitting wireless signals, such as radio frequency signals.

The scanning sensor assemblies 108-110 operate in order to maintain alignment between the sensor heads 210a-210b. For example, the carriage 204a of the master sensor assembly 108 can move back and forth along the track 202a according to a motion profile (thereby moving the sensor head 210a). At the same time, the carriage 204b of the follower sensor assembly 110 can follow the movement of the master sensor assembly 108 so that the sensor heads 210a-210b maintain substantially the same cross direction location or a substantially fixed offset that does not change with movement. Note that the term “alignment” here refers to a desired relationship between sensor heads, including situations where the sensor heads have substantially the same cross direction position and situations where the sensor heads have a desired amount of offset in their cross direction positions.

As noted above, sensors can become misaligned during use due to a variety of factors, such as manufacturing and installation differences or position tracking errors during movement. For example, FIGS. 2B and 2C illustrate potential alignment errors that may occur between the sensors 212a-212b during scanning operations.

FIG. 2B illustrates an enlarged view of the sensor heads 210a-210b. Although the sensor heads 210a-210b are substantially in alignment with each other, the sensors 212a-212b are mounted differently on their respective sensor heads due to one or more manufacturing or installation differences. For example, even if the sensor heads 210a-210b are substantially identical, the positions of mounting points for the sensors 212a-212b may be slightly different between the sensor heads 210a-210b. Likewise, if each sensor head 210a-210b includes multiple mounting points for the sensors 212a-212b, an installer may select a different mounting point in the sensor head 210a to install the sensor 212a than he or she selects in the sensor head 210b to install the sensor 212b. In such cases, center lines (CLs) of the sensors 212a-212b may not be in alignment and therefore create an alignment error 240, even though the sensor heads 210a-210b are substantially in alignment. Such an alignment error 240 can be referred to as a constant offset error because it is not likely to change during scanner operation.

FIG. 2C illustrates a graph of the overall cross-direction sensor alignment error as the cross positions of the sensor heads 210a-210b (and thus the sensors 212a-212b) change during a scan. The overall alignment error changes with the cross position. The overall alignment error may include the constant offset error 240 due to manufacturing or installation differences or other factors. The overall alignment error may also include a variable dynamic position tracking error 245 that may occur during a scanning operation. This could be due, for example, to limitations in the tracking abilities of the follower sensor assembly 110 to follow the movement of the master sensor assembly 108.

Various techniques may be used by the follower sensor assembly 110 to improve or maintain the desired alignment with the master sensor assembly 108 while a scan operation is in progress. Some of these alignment techniques rely on an assumption that the sensor assemblies 108-110, the sensor heads 210a-210b, or the sensors 212a-212b are in alignment at a static predefined “zero starting point” or baseline before a scan operation occurs. That is, in order for the follower sensor assembly 110 to improve or maintain the desired alignment with the master sensor assembly 108 during a scan, the follower sensor assembly 110 calibrates alignment of the sensors 212a-212b before the scan to account for any constant offset error 240.

In accordance with this disclosure, alignment of the web sensors 212a-212b may be calibrated before a scan by measuring sensor sensitivity across a range of deliberate misalignments. For example, one or more components of the scanning sensor assemblies 108-110 (such as the web sensors 212a-212b, the position sensors 214a-214b, and the controller 216) may be used in an alignment calibration process before a scanning process is performed. The alignment calibration process is described in greater detail below.

Although FIGS. 2A through 2C illustrate examples of scanning sensor assemblies 108-110 in the system 100 of FIG. 1 and examples of potential alignment errors that may occur between sensor assemblies 108-110 during scanning operations in the system 100 of FIG. 1, various changes may be made to FIGS. 2A through 2C. For example, various components in each scanning sensor assembly 108-110 could be combined, further subdivided, or omitted and additional components could be added according to particular needs. Also, the form of each assembly with a carriage 204a-204b connected to a separate sensor head 210a-210b is for illustration only. Each sensor head 210a-210b could incorporate or be used with a carriage in any suitable manner.

FIG. 3 illustrates an example scanning sensor head 210b in the scanning sensor assembly 110 of FIG. 1 in accordance with this disclosure. It will be understood that the scanning sensor head 210a could be configured the same as or similar to the scanning sensor head 210b.

As shown in FIG. 3, the sensor head 210b includes a moveable chassis 302, which represents a housing or other structure configured to encase, contain, or otherwise support other components of the sensor head 210b. The chassis 302 can be formed from any suitable material(s) (such as metal) and in any suitable manner.

As described above, the sensor head 210b includes at least one web sensor 212b and at least one position sensor element 214b. The sensor head 210b also includes a power supply/receiver 304, which provides operating power to the sensor head 210b. For example, the power supply/receiver 304 could receive AC or DC power from an external source, and the power supply/receiver 304 could convert the incoming power into a form suitable for use in the sensor head 210b. The power supply/receiver 304 includes any suitable structure(s) for providing operating power to the sensor head 210b, such as an AC/DC or DC/DC power converter. The power supply/receiver 304 may also include a battery, capacitor, or other power storage device.

A controller 306 controls the overall operation of the sensor head 210b. For example, the controller 306 could receive measurements associated with one or more characteristics of the web 102 from the web sensor 212b. The controller 306 could also receive positional measurements associated with the position of the sensor head 210b from the position sensor element 214b. The positional measurements could correlate the position of the sensor head 210b with respect to another sensor head or with respect to the web 102 or a reference point. The controller 306 could further control the transmission of this data to the controller 216 or other destination(s). The controller 306 includes any suitable processing or control device(s), such as one or more microprocessors, microcontrollers, digital signal processors, field programmable gate arrays, or application specific integrated circuits. Note that the controller 306 could also be implemented as multiple devices.

A motor controller 308 can be used to control the operation of one or more motors, such as one or more of the motors 206a-206b, 208a-208b. For example, the motor controller 308 could generate and output pulse width modulation (PWM) or other control signals for adjusting the direction and speed of the motor 206b. The direction and speed could be controlled based on input from the controller 306. The motor controller 308 includes any suitable structure for controlling operation of a motor.

A wireless transceiver 310 is coupled to the antenna(s) 224b. The wireless transceiver 310 facilitates the wireless transmission and reception of data, such as by transmitting web measurements, positional measurements, and related data to the controller 216 and receiving commands from the controller 216. The wireless transceiver 310 includes any suitable structure for generating signals for wireless transmission and/or for processing signals received wirelessly. In particular embodiments, the wireless transceiver 310 represents a radio frequency (RF) transceiver. Note that the transceiver 310 could be implemented using a transmitter and a separate receiver.

Although FIG. 3 illustrates one example of a scanning sensor head 210b in the scanning sensor assembly 110 of FIG. 1, various changes may be made to FIG. 3. For example, various components in FIG. 3 could be combined, further subdivided, or omitted and additional components could be added according to particular needs. As a particular example, a single controller or more than two controllers could be used to implement the functions of the controllers 306-308. Additionally or alternatively, one or both controllers 306-308 could be located external to the scanning sensor head 210b, such as at the external controller 216 or at any other suitable location.

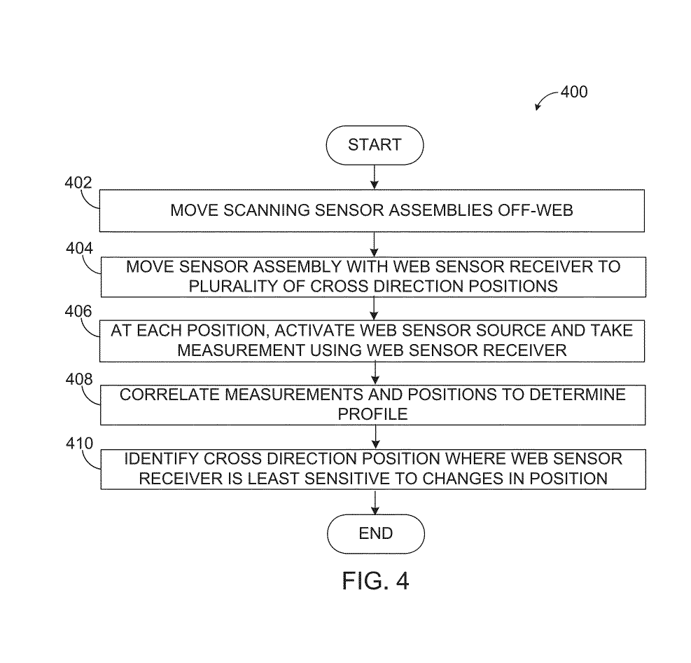

FIG. 4 illustrates an example method 400 for calibrating an alignment of sensors installed on independently-driven scanning sensor heads in accordance with this disclosure. For ease of explanation, the method 400 is described with respect to the scanning sensor assemblies 108-110 of FIG. 2A operating in the system 100 of FIG. 1. The method 400 could be performed by any other suitable device(s) and in any other suitable system(s).

The method 400 for alignment calibration can be performed “off-web” (meaning without using a web being manufactured or processed), such as during a maintenance period or cycle. As a particular example, the method 400 could be performed when part or all of a sensor (such as one of the web sensors 212a-212b) is replaced, repaired, or otherwise adjusted with respect to its corresponding sensor head. The method 400 can be performed with no sheet between the web sensors 212a-212b or with a “dummy” sheet having known properties between the web sensors 212a-212b.

As shown in FIG. 4, the scanning sensor assemblies 108-110 (along with their corresponding web sensors 212a-212b) are taken off-web to a starting position at step 402. In the following discussion, the web sensor 212a may represent a source element, and the web sensor 212b may represent a receiver element.

While the sensor assembly 108 (and the web sensor source 212a) remains in the starting position, the sensor assembly 110 (and the web sensor receiver 212b) moves to a plurality of cross direction positions relative to the sensor assembly 108 at step 404. Each cross direction position of the sensor assembly 110 relative to the sensor assembly 108 can be pre-determined or measured upon arrival of the sensor assembly 110 at the position (such as by using one or more position sensors 214a-214b). The multiple cross direction positions can span a range covering both sides of the estimated position of the center line of the web sensor 212a (such as a range spanning from 10 mm to the left of the web sensor 212a to 10 mm to the right of the web sensor 212a). The multiple cross direction positions can be evenly spaced, such as every 1 mm. However, the cross direction positions may be unevenly spaced or may be randomly or semi-randomly selected.

At step 406, at each of the cross direction positions, the web sensor 212a is activated, and the intensity of a signal from the web sensor 212a is measured at the web sensor 212b. For comparison purposes, the intensity of the signal emitted from the web sensor 212a could be the same for each position; however, differences in alignment at the multiple positions cause different measurements at the web sensor 212b. The measurement of the signal intensity at each cross direction position is recorded along with the corresponding cross direction position.

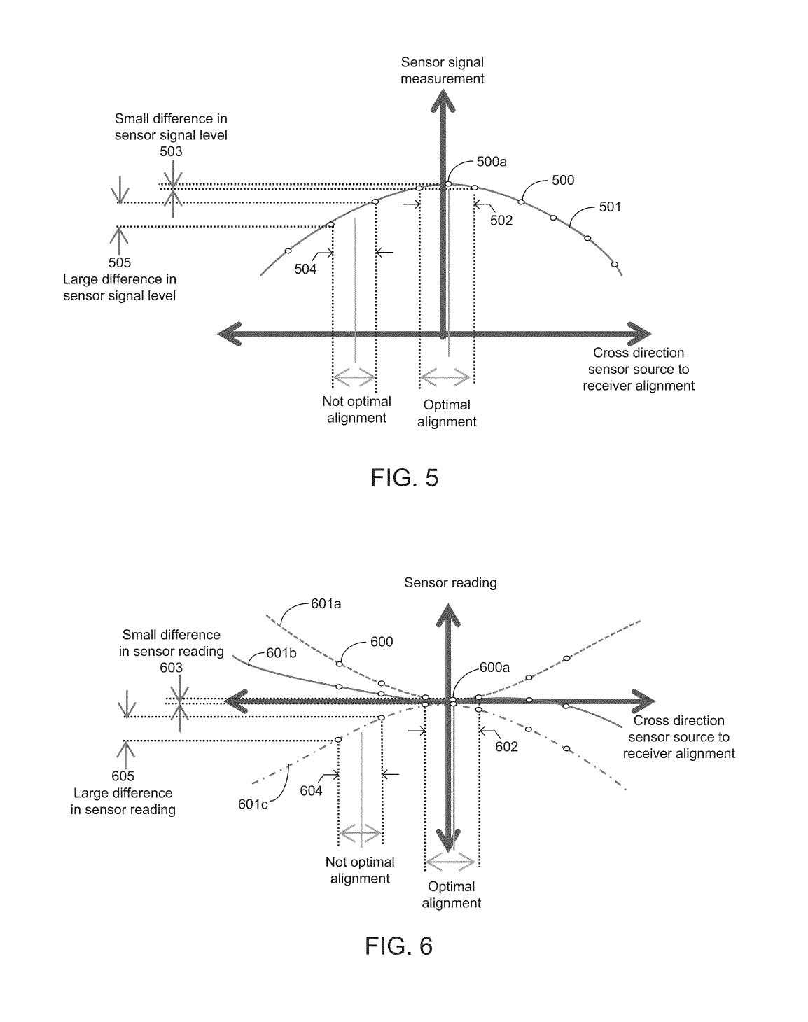

At step 408, a controller (such as the controller 216 or the controller 306) correlates the signal intensity measurements and the cross direction positions to mathematically determine a receiver measurement versus cross direction position profile. The profile could have any suitable form that associates receiver measurements and cross direction positions. FIG. 5 illustrates an example chart showing sensor signal outputs versus cross direction position profiles in accordance with this disclosure. As shown in FIG. 5, the x-axis indicates the cross direction position of the sensor assembly 110 relative to the sensor assembly 108. Positive values indicate that the sensor assembly 110 is positioned to one side of the sensor assembly 108 in the cross direction, and negative values indicate that the sensor assembly 110 is positioned to the other side of the sensor assembly 108. The y-axis indicates the magnitude of the sensor signal output of the web sensor 212a as measured at the web sensor 212b (such as the signal voltage). Each data point 500 represents a measured sensor signal intensity at a corresponding cross direction position of the sensor assembly 110. A plot 501 represents the sensor signal intensity profile across a range of cross direction positions.

At step 410, the controller identifies a cross direction position where the web sensor 212b is least sensitive to changes in the cross direction position. For example, in FIG. 5, in the region surrounding data point 500a, the profile plot 501 exhibits a flat portion 502 where small alignment changes to the left or right of the data point 500a do not result in significant differences 503 in signal intensity measurements. In particular, at the data point 500a, the profile plot 501 has a zero slope. Thus, the web sensor 212b is considered to be less sensitive to changes in the cross direction position within the region 502 and least sensitive at the data point 500a. In contrast, in regions where the sensors are not aligned (such as the region 504), the profile may exhibit a non-zero slope such that slight alignment changes to the left or right result in noticeable measurement differences 505.

Based on the data plot 501 shown in FIG. 5, the controller selects the cross direction position corresponding to the data point 500a as the position of the sensor assembly 110 (relative to the sensor assembly 108) at which the web sensor 212b is least sensitive to cross direction alignment error. It is at this position that the web sensors 212a-212b are assumed to be in the best alignment. Once selected, the new optimal head-to-head position is maintained during scanning. It is noted that, due to the constant offset error 240, the data point 500a may not coincide with perfect alignment of the sensor assemblies 108-110. In fact, it is for this reason that the method 400 is performed.

For many sensors, the point of best alignment coincides with the largest measurement of signal intensity, such as at the data point 500a in FIG. 5. However, in some cases, the sensor measurement is not linearly related to signal intensity but rather is ratio-based. For example, in some infrared sensor systems, the sensor measurement at the web sensor 212b is a ratio of signal to wavelength or a ratio of two or more wavelengths. In such cases, the sensor profile may not be an inverted parabola like the profile plot 501, and the point of best alignment may not simply coincide with the largest sensor measurement.

FIG. 6 illustrates an example chart showing sensor measurement readings versus cross direction positions for multiple types of sensors in accordance with this disclosure. As in FIG. 5, the x-axis in FIG. 6 indicates the cross direction position of the sensor assembly 108 relative to the sensor assembly 110. Here, the y-axis indicates the measurement reading of the web sensor 212b. Plots 601a-601c represent measurement reading profiles for each of three different types of web sensors 212a-212b across a range of cross direction alignments, and each data point 600 represents a sensor measurement reading at a corresponding cross direction position of the sensor assembly 110.

Similar to the profile plot 501 in FIG. 5, each of the profile plots 601a-601c in FIG. 6 exhibits a flat portion 602 where small alignment changes to the left or right of a data point 600a do not result in significant differences 603 in sensor measurement readings. In particular, at the data point 600a, each profile plot 601a-601c has a zero or minimum slope. Thus, the web sensor 212b is considered to be less sensitive to changes in the cross direction position within the region 602 and least sensitive at the data point 600a. In contrast, in regions where the sensors are not aligned (such as the region 604), each profile may exhibit a non-zero slope where slight alignment changes to the left or right result in noticeable measurement differences 605. The controller selects the cross direction position corresponding to the data point 600a as the position of the sensor assembly 110 (relative to the sensor assembly 108) at which the web sensor 212b is least sensitive to cross direction alignment error. This position is selected even though the sensor measurement at the web sensor 212b may not be a maximum.

Using the method 400 as described above, the optimum alignment point between upper and lower sensor heads can be determined automatically to reduce cross direction alignment errors rather than relying on a visual or mechanical alignment of external enclosures. In systems where head-to-head alignment sensors are available (such as the position sensors 214a-214b), such alignment sensors can be used in a feedback loop during scanning to maintain an alignment set point. If no position sensor is available, motor encoder or stepper motor steps from the drive can be used to offset the heads prior to scanning.

Although FIG. 4 illustrates one example of a method 400 for calibrating the alignment of web sensors, various changes may be made to FIG. 4. For example, while shown as a series of steps in each figure, various steps in FIG. 4 could overlap, occur in parallel, occur in a different order, or occur any number of times. Additionally, while the method 400 has been described with respect to cross direction alignment, the method 400 may also be used for alignment calibration in other dimensions. For instance, if machine direction or vertical direction offset errors occur during a full width scan, full width test scans can be conducted at different cross direction offsets to search for a global error minimum. In addition, note that the characteristics shown in FIGS. 5 and 6 are for illustration only.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit” and “receive,” as well as derivatives thereof, encompass both direct and indirect communication. The terms “include” and “comprise,” as well as derivatives thereof; mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
moving a first sensor assembly to a plurality of cross direction positions relative to a second sensor assembly, the first and second sensor assemblies configured to move in the cross direction relative to a web of material;
for each of the plurality of cross direction positions, determining a sensor value associated with a sensor source disposed at the second sensor assembly as measured by a sensor receiver disposed at the first sensor assembly; and
determining a starting alignment position of the first sensor assembly to be a first cross direction position where a difference between the sensor value at the first cross direction position and a corresponding sensor value at one or more adjacent cross direction positions is a minimum.

2. The method of claim 1, wherein each sensor value comprises a sensor reading or a magnitude of a sensor voltage signal.

3. The method of claim 1, wherein:
the sensor source comprises a source element configured to generate an emission; and
the sensor receiver comprises a receiving element configured to measure the emission.

4. The method of claim 3, wherein:
the source element is configured to emit at least one of: nuclear radiation, infrared light, visible light, and a magnetic field; and
the receiving element is configured to measure the at least one of: nuclear radiation, infrared light, visible light, and a magnetic field.

5. The method of claim 1, further comprising:
correlating the sensor values and the corresponding cross direction positions to determine a sensor value versus position profile curve.

6. The method of claim 5, wherein the first cross direction position coincides with a zero slope or minimum slope of the profile curve.

7. The method of claim 1, wherein determining the sensor value for each cross direction position comprises activating the sensor source and measuring a received signal at the sensor receiver.

8. The method of claim 1, wherein the cross direction positions span a range covering opposite sides of an estimated position of a center line of the sensor source.

9. The method of claim 8, wherein the cross direction positions are evenly spaced.

10. The method of claim 1, wherein the method is performed off-web during a maintenance period.

11. An apparatus comprising:
a first sensor assembly configured to move in a cross direction relative to a web of material, the first sensor assembly comprising:
a sensor receiver configured to receive and measure emissions from a sensor source disposed at a second sensor assembly; and
at least one controller configured to:
control a motor configured to move the first sensor assembly to a plurality of cross direction positions relative to the second sensor assembly;
determine, for each of the plurality of cross direction positions, a sensor value associated with the sensor source as measured by the sensor receiver; and
determine a starting alignment position of the first sensor assembly to be a first cross direction position where a difference between the sensor value at the first cross direction position and a corresponding sensor value at one or more adjacent cross direction positions is a minimum.

12. The apparatus of claim 11, wherein each sensor value comprises a sensor reading or a magnitude of a sensor voltage signal.

13. The apparatus of claim 11, wherein:
the sensor source comprises a source element configured to generate the emissions; and
the sensor receiver comprises a receiving element configured to measure the emissions.

14. The apparatus of claim 13, wherein:
the source element is configured to emit at least one of: nuclear radiation, infrared light, visible light, and a magnetic field; and
the receiving element is configured to measure the at least one of: nuclear radiation, infrared light, visible light, and a magnetic field.

15. The apparatus of claim 11, wherein the controller is further configured to correlate the sensor values and the corresponding cross direction positions to determine a sensor value versus position profile curve.

16. The apparatus of claim 15, wherein the first cross direction position coincides with a zero slope or minimum slope of the profile curve.

17. The apparatus of claim 11, wherein the cross direction positions span a range covering opposite sides of an estimated position of a center line of the sensor source.

18. The apparatus of claim 17, wherein the cross direction positions are evenly spaced.

19. A system comprising:
a first sensor assembly and a second sensor assembly, the first sensor assembly configured to be disposed on a first side of a web of material and to move in a cross direction relative to the web, the second sensor head configured to be disposed on a second side of the web opposite the first side and to move in the cross direction;
the first sensor assembly further configured to:
move to a plurality of cross direction positions relative to the second sensor assembly;
for each of the plurality of cross direction positions, determine a sensor value associated with a sensor source disposed at the second sensor assembly as measured by a sensor receiver disposed at the first sensor assembly; and
determine a starting alignment position of the first sensor assembly to be a first cross direction position where a difference between the sensor value at the first cross direction position and a corresponding sensor value at one or more adjacent cross direction positions is a minimum.

20. A non-transitory computer readable medium embodying a computer program, the computer program comprising computer readable program code for:
moving a first sensor assembly to a plurality of cross direction positions relative to a second sensor assembly, the first and second sensor assemblies configured to move in the cross direction relative to a web of material;
for each of the plurality of cross direction positions, determining a sensor value associated with a sensor source disposed at the second sensor assembly as measured by a sensor receiver disposed at the first sensor assembly; and
determining a starting alignment position of the first sensor assembly to be a first cross direction position where a difference between the sensor value at the first cross direction position and a corresponding sensor value at one or more adjacent cross direction positions is a minimum.
